(19) United States
(12) Patent Application Publication
(10) Pub. No.: US 2003/0132313 A1
(43) Pub. Date: Jul. 17, 2003

(54) Container structure on which an atomizer can be more conveniently and sealedly installed

(76) Inventor: Tine Sheng-Ming, Taiching Hsien (TW)

Correspondence Address: BRUCE H. TROXELL, SUITE 1404, 5205 LEESBURG PIKE, FALLS CHURCH, VA, 22041, US

(21) Appl. No.: 10/043,315

(22) Filed: Jan. 14, 2002

(51) Int. Cl. B05B 9/043

(52) U.S. Cl. 239/333; 239/331

(57) ABSTRACT

Container structure on which an atomizer can be more conveniently and sealedly installed, including: a container having an opening and at least two first engaging sections formed on outer circumference of the opening; an atomizer seat disposed on the opening of the container and having a first receiving space at lower end thereof, the first receiving space having an opening facing downward, at least two second engaging sections being formed on inner wall of the first receiving space for engaging with the corresponding first engaging sections, a hollow post downward extending from the top of the first receiving space to the open end, a second annular receiving space with a certain depth being defined between the outer circumference of the hollow post and the inner wall of the first receiving space, the opening of the container being tightly inserted in the second receiving space; and an atomizer assembly disposed on the atomizer seat and including a movable valve communicating with the interior of the container through a predetermined passage.

### BACKGROUND OF THE INVENTION

The present invention is related to a container structure on which an atomizer can be more conveniently and sealedly installed. With the container structure, the atomizer is not subject to dropping from the opening of the container and a better sealing effect is achieved to avoid leakage of the content in the container.

A variety of containers have been developed for containing detergents, beverages, shampoos, cosmetics, etc. Such containers have various shapes, colors and stripes and are made of different materials. Some of the containers have no dispenser or atomizer. With respect to such containers, the contents contained in the containers are directly poured out or squeezed out of the containers. With respect to those containers equipped with depression dispensers (such as shampoo containers) or atomizers (such as perfume bottles), the contents are dispensed or sprayed out of the containers.

FIG. 1 shows a conventional atomizer structure installed on a container 60. The atomizer structure includes an atomizer seat 4 and an atomizer assembly 3 disposed on the atomizer seat 4. The container 60 has an opening 61 formed with outer thread. The atomizer seat 4 is formed with a recess 411. The inner face of the wall defining the recess 411 is formed with inner thread, whereby the atomizer seat 4 is screwed on the opening 61. The atomizer assembly 3 includes a movable valve 31, a locating member 32, a conduit 33, a steel ball 34, a spring 35, a movable stem 36 and a plug 37. The atomizer seat 4 is fixedly connected with the locating member 32. The locating member 32 is formed with a cavity in which the movable valve 31, movable stem 37 and the plug 37 are received. When a user presses the movable valve 31 to separate the movable stem 36 from the shaft of the movable valve 31, the content in the container 60 is sucked upward through the conduit 33 and sprayed out from the movable valve 31.

The threads of the atomizer seat 4 and the opening 61 of the container 60 often only have two to three teeth. When a user extracts a cap of the bottle, the atomizer seat 4 is often unexpectedly screwed and loosened or even detached from the opening of the bottle. This will lead to leakage of the content. Furthermore, when assembled, the atomizer seat 4 must be tightly screwed onto the opening by two to three loops. Such procedure is inconvenient.

FIG. 2 shows an improved atomizer structure in which a flange is formed on the circumference of the opening 61′ of the bottle and the inner face of the wall of the atomizer seat 4′ is formed with an annular groove 411′ for engaging with the flange 62′. Such structure prevents the atomizer seat 4′ from being unexpectedly screwed and loosened. However, in the case that the container is made of soft material and has a slender shape, when the head of the container suffers an impact or bending force, the atomizer seat 4′ still may loosen or even drop. Moreover, in case the flange and the annular groove are not sealedly engaged with each other and a gap exists there between, the content may infiltrate through the gap.

### SUMMARY OF THE INVENTION

It is therefore a primary object of the present invention to provide a container structure on which an atomizer can be more conveniently and sealedly installed. With the container structure, the atomizer is more firmly connected with the opening of the container and is not subject to dropping from the opening. The atomizer can be easily assembled with the opening of the container.

It is a further object of the present invention to provide the above container structure by which a better sealing effect is achieved so that the content in the container is not subject to leaking.

The present invention can be best understood through the following description and accompanying drawings wherein:

### BRIEF DESCRIPTION OF THE DRAWINGS

FIG. 1 is an axially sectional view of a conventional atomizer structure;

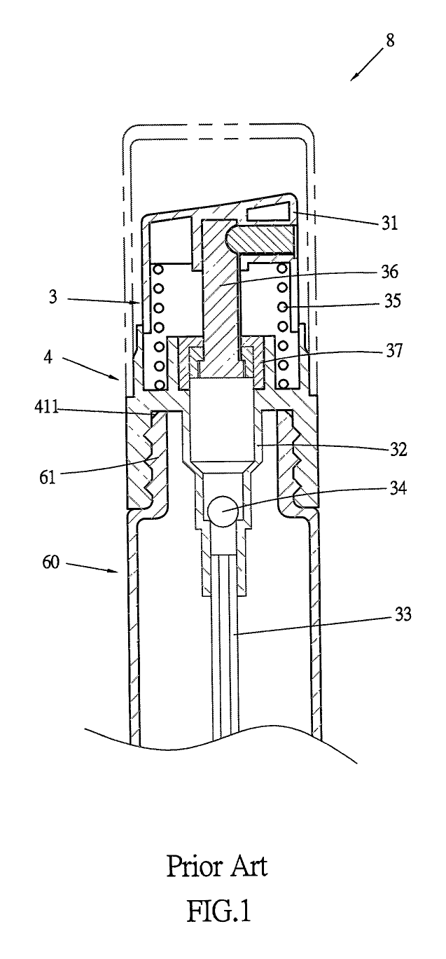

FIG. 2 is an axially sectional view of another type of conventional atomizer structure;

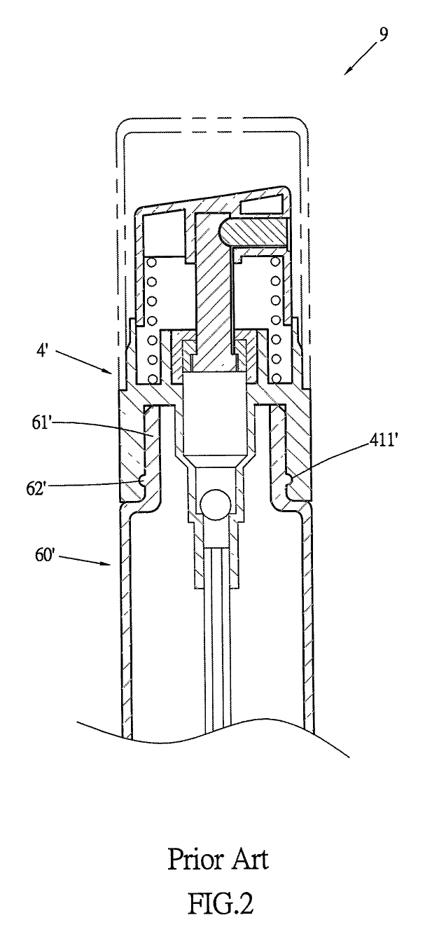

FIG. 3 is a perspective exploded view of a preferred embodiment of the present invention;

FIG. 4 is an axially sectional view of the preferred embodiment of the present invention;

FIG. 5 is an axially sectional view of another embodiment of the present invention;

FIG. 6 is an axially sectional view of still another embodiment of the present invention; and

FIG. 7 is an axially sectional view of still another embodiment of the present invention.

### DETAILED DESCRIPTION OF THE PREFERRED EMBODIMENTS

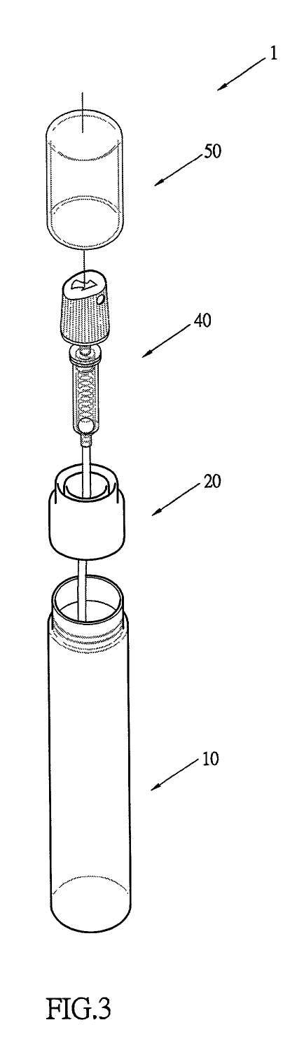

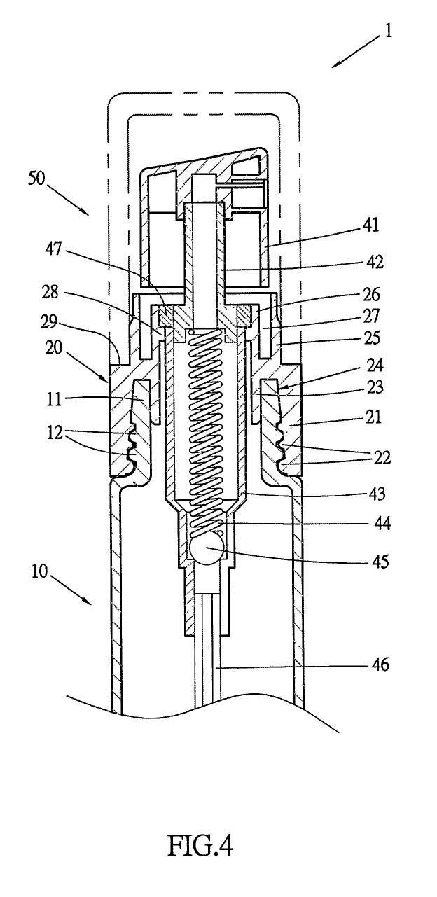

Please refer to FIGS. 3 and 4. The container structure 1 on which an atomizer can be more conveniently and sealedly installed according to the present invention includes a container 10, an atomizer seat 20 disposed at one end of the container 10, an atomizer assembly 40 disposed on the atomizer seat 20 and a cylindrical cap 50 fitted on the atomizer seat 20.

The container 10 has an opening 11 and two first engaging sections 12 integrally formed on outer circumference of the opening 11. In this embodiment, the first engaging sections 12 are annular ribs.

The atomizer seat 20 has a lower barrel section 21 having an opening facing downward. Two second engaging sections 22 are formed on inner circumference of the barrel section 21 near the opening. In this embodiment, the second engaging sections 22 are annular ribs. A hollow post 23 downward extends from lower face of upper end of the barrel section 21 by a predetermined length. The lower end of the hollow post 23 is spaced from the lower end of the barrel section 21 by a certain distance. A receiving space 24 is defined between the outer circumference of the hollow post 23 and the inner circumference of the barrel section 21. The atomizer seat 20 has a cylindrical upper guiding section 25 having an opening facing upward. A hollow post 26 upward extends from the center of the bottom of the guiding section 25. A guiding space 27 is defined between outer circumference of the hollow post 26 and the inner circumference of the guiding section 25. An engaging flange 28 is formed on inner circumference of the hollow post 26 in a predetermined position. A cap seat 29 is formed on the atomizer seat 20 in a predetermined position. The cap 50 is detachably fitted on the cap seat 29.

The atomizer assembly 40 includes a movable valve 41, a movable stem 41, a locating member 43, a plug 47, a spring 44, a steel ball 45 and a conduit 46 which are sequentially arranged in the hollow post 23 and the hollow post 26 to form a passage communicating inner side of the container 10 with outer side thereof. The content in the container 10 can be sprayed out through the passage.

When assembled, the atomizer assembly 40 is inlaid into the atomizer seat 20 and engaged with the engaging flange 28. The movable valve 41 of the atomizer assembly 40 is positioned above the guiding section 25 and spaced from the top face thereof by a predetermined distance. Then, the atomizer assembly 40 together with the atomizer seat 20 is fitted on the opening 11 of the container with the opening 11 directly inserted into the receiving space 24 and tightly leant against the outer circumference of the hollow post 23. Also, the first engaging ribs 12 and the second engaging ribs 22 are engaged with each other. Finally, the cap 50 is fitted onto the cap seat 29.

The first engaging ribs 12 and the second engaging ribs 22 are rotatably engaged with each other so that in case the atomizer seat 20 is rotated, the atomizer seat 20 is prevented from detaching from the opening 11. The multifold engagements enhance the sealing effect and avoid leakage of the content. Moreover, the hollow post 23 is able to reinforce the opening 11 of the container so that the opening 11 is not subject to deformation or bending when suffering external force or impact. Therefore, the atomizer seat 20 is prevented from easily detaching from the opening 11.

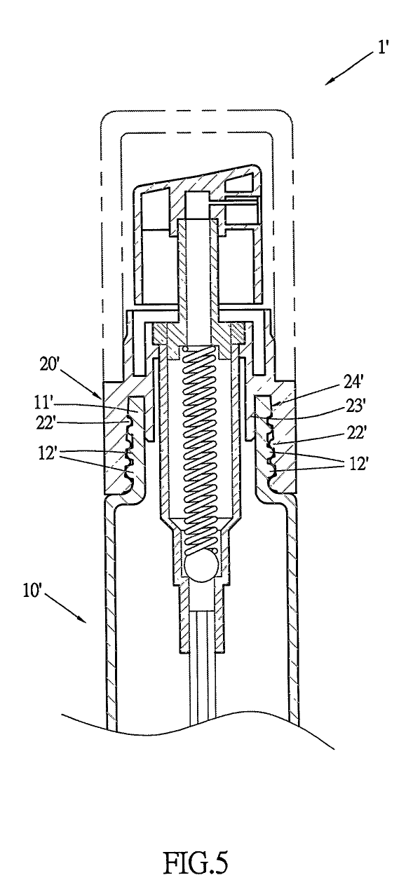

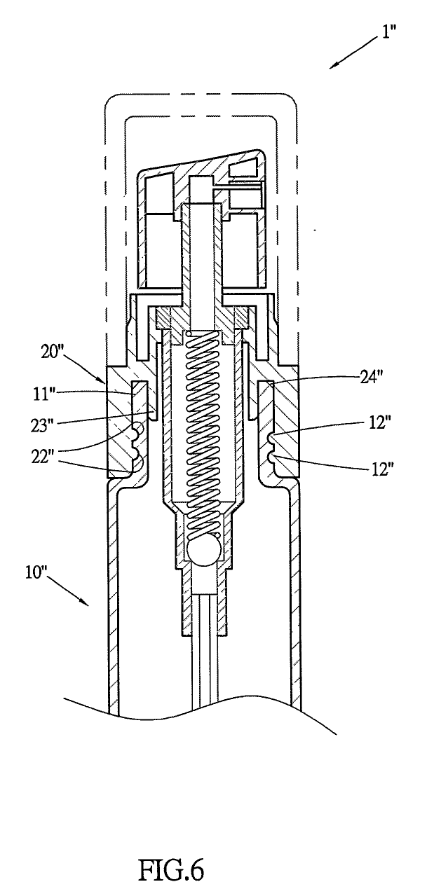

FIG. 5 shows another embodiment of the present invention, in which a group of first engaging ribs 12′ and a group of corresponding second engaging ribs 22′ are formed on inner wall of the receiving space 24′. The hollow post 23′ presses the first engaging ribs 12′ against the second engaging ribs 22′ so as to achieve firmer engagement. FIG. 6 shows still another embodiment of the present invention, in which the first engaging sections 12″ are annular ribs, while the second engaging sections 22″ are annular grooves corresponding to the first engaging sections 12″.

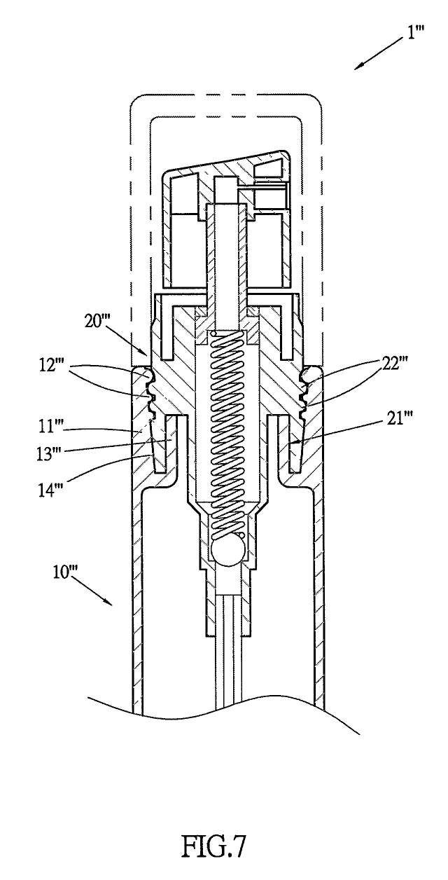

FIG. 7 shows still another embodiment of the container structure 1′″ of the present invention, in which a hollow post 13′″ is integrally formed on inner side of the opening 11′″ of the container instead of the hollow post 23. The outer circumference of the hollow post 13′″ and the inner circumference of the opening 11′″ define there between a receiving space 14′″ . The barrel-shaped lower end of the atomizer seat 20′″ is tightly inserted into the receiving space 14′″. The first engaging sections 12′″ are formed on inner circumference of the opening 11′″, while the second engaging sections 22′″ are formed on outer circumference of the atomizer seat 20′″ and engaged with the first engaging sections 12′″. The hollow post 26′″ of the atomizer seat 20′″ and the locating member 43′″ of the atomizer assembly 40′″ are integrally formed.

According to the above arrangement, the present invention has the following advantages:

1. Manifold first engaging sections 12 and second engaging sections 22 cooperate with each other so that the atomizer seat 20 is more firmly connected with the opening 11 of the container. The atomizer seat 20 can be conveniently assembled with the opening 11 and a better sealing effect is achieved. When using the container or extracting the cap, the atomizer seat is prevented from being unexpectedly loosened or detached from the opening 11.

2. The hollow post 23 of the atomizer seat 20 is tightly fitted with the inner circumference of the opening 11 to enhance the bending strength of the atomizer seat 20 and the opening 11. Moreover, the opening 11 is better sealed.

The above embodiments are only used to illustrate the present invention, not intended to limit the scope thereof. Many modifications of the above embodiments can be made without departing from the spirit of the present invention.

What is claimed is:

1. Container structure on which an atomizer can be more conveniently and sealedly installed, comprising:
a container having an opening and at least two first engaging sections formed on outer circumference of the opening, the first engaging sections being annular ribs;
an atomizer seat disposed on the opening of the container, the atomizer seat having a lower barrel section having an opening facing downward, the inner diameter of the barrel section being tapered from the opening to the top of the barrel section, at least two second engaging sections which are annular ribs being formed on inner circumference of the barrel section, the second engaging sections being sequentially arranged from larger one to smaller one, the largest second engaging section being positioned in a predetermined position near the open end of the atomizer seat, the second engaging sections being engaged with the corresponding first engaging sections, whereby when assembled, at least one first engaging section is engaged between two adjacent second engaging sections, a hollow post downward extending from lower face of upper end of the barrel section to the open end by a predetermined length, an annular receiving space with a predetermined depth being defined between the outer circumference of the hollow post and the inner circumference of the barrel section, the opening of the container being tightly inserted in the receiving space; and
an atomizer assembly disposed on the atomizer seat and including a movable valve, a movable stem, a plug, a locating member, a spring, a steel ball and a conduit, the movable valve communicating with the interior of the container through a predetermined passage.

2. Container structure on which an atomizer can be more conveniently and sealedly installed as claimed in claim 1, wherein at least one first engaging section and at least one second engaging section correspond to each other in the receiving space.

3. Container structure on which an atomizer can be more conveniently and sealedly installed as claimed in claim 1, wherein the first engaging sections are annular ribs, while the second engaging sections are annular grooves corresponding to the annular ribs.

4. Container structure on which an atomizer can be more conveniently and sealedly installed as claimed in claim 1, wherein the hollow post of the atomizer seat and the locating member of the atomizer assembly are separate members.

5. Container structure on which an atomizer can be more conveniently and sealedly installed as claimed in claim 1, wherein the hollow post of the atomizer seat and the locating member of the atomizer assembly are integrally formed.

6. Container structure on which an atomizer can be more conveniently and sealedly installed, comprising:
a container having an opening, a hollow post being integrally formed on inner side of the opening of the container at the center thereof, the outer circumference of the hollow post and the inner circumference of the opening defining therebetween a receiving space, at least two first engaging sections which are annular ribs being formed on inner circumference of the opening;
an atomizer seat disposed on the opening of the container and having a lower barrel section which is inserted in the receiving space to abut against outer circumference of the hollow post, at least two second engaging sections which are annular ribs being formed on outer circumference of the barrel section of the atomizer seat in predetermined position, whereby when assembled, at least one first engaging section is engaged between two adjacent second engaging sections; and
an atomizer assembly disposed on the atomizer seat and including a movable valve, a movable stem, a plug, a locating member, a spring, a steel ball and a conduit, the movable valve communicating with the interior of the container through a predetermined passage.

7. Container structure on which an atomizer can be more conveniently and sealedly installed as claimed in claim 6, wherein at least one first engaging section and at least one second engaging section correspond to each other in the receiving space.

8. Container structure on which an atomizer can be more conveniently and sealedly installed as claimed in claim 6, wherein the first engaging sections are annular ribs, while the second engaging sections are annular grooves corresponding to the annular ribs.

9. Container structure on which an atomizer can be more conveniently and sealedly installed as claimed in claim 6, wherein the hollow post of the atomizer seat and the locating member of the atomizer assembly are separate members.

10. Container structure on which an atomizer can be more conveniently and sealedly installed as claimed in claim 6, wherein the hollow post of the atomizer seat and the locating member of the atomizer assembly are integrally formed.
